(19) United States
(12) Patent Application Publication
(10) Pub. No.: US 2024/0282508 A1
(43) Pub. Date: Aug. 22, 2024

(54) INDUCTOR, AND ELECTRONIC AND ELECTRIC EQUIPMENT

(71) Applicant: Alps Alpine Co., Ltd., Tokyo (JP)

(72) Inventors: Akinori KOJIMA, Niigata-ken (JP); Taishi NUMATA, Niigata-ken (JP)

(21) Appl. No.: 18/399,386

(22) Filed: Dec. 28, 2023

(30) Foreign Application Priority Data
Feb. 20, 2023 (JP) 2023-024568

(51) Int. Cl. H01F 27/29; H01F 1/147; H01F 1/153; H01F 27/255

(52) U.S. Cl. CPC H01F 27/292; H01F 1/14708; H01F 1/15308; H01F 27/255

(57) ABSTRACT

An inductor includes connecting terminals, a conductor that is electrically connected to the connecting terminals and can generate an induction field by electrification, and a core (pressed powder core) that embeds at least a part of the conductor and includes a metal powder. When electrical characteristics obtained by application of AC to the inductor are fitted using the equation with two parameters a and b: ACR/L=a×Iop^{b}, where the parameter a is 100 (unit: mΩμH⁻¹A^{-b}) or less, ACR is an AC resistance value (unit: mΩ) when AC of 1 MHz is applied, L is self-inductance (unit: μH), Iop is ripple current amplitude (unit: A) of the applied AC, and the other parameter b is a dimensionless parameter.

### CLAIM OF PRIORITY

This application claims benefit of Japanese Patent Application No. 2023-024568 filed on Feb. 20, 2023, which is hereby incorporated by reference.

### BACKGROUND OF THE INVENTION

### 1. Field of the Invention

The present invention relates to an inductor and electronic and electric equipment mounted with the inductor.

### 2. Description of the Related Art

In recent years, a demand for miniaturization of switching power supply circuits, in particular, DC-DC converters, to be incorporated in electronic equipment such as a smart phone, a tablet terminal, and a notebook PC is particularly increasing. As a result of meeting this demand, a large amount of direct current flows in an inductor to be incorporated in the inside of electronic equipment, despite the inductor being small. Accordingly, when the induction field caused by this direct current is applied as bias, the magnetic environment in which a magnetic material constituting the inductor is placed is an environment in which a variable magnetic field caused by current fluctuation (ripple current) based on switching at a high frequency is further applied. Accordingly, the magnetic member constituting the inductor is required to have appropriate electrical characteristics (for example, low ACR/L and high efficiency) in such a magnetically harsh environment. Here, the ACR/L means (alternating-current (AC) resistance value ACR)/(self-inductance L), and the efficiency means the proportion (unit: %) of output power to input power of an inductor.

In order to meet such demands, International Publication No. WO 2008/007705 proposes a stacked inductor in which electrically insulating magnetic layers and conductor patterns are stacked and thereby the conductor patterns are sequentially connected to form a coil that goes around in a spiral while being superimposed in the stacking direction in a magnetic material, and both ends of the coil are extracted to the outer surface of a stack chip through lead-out conductors and are respectively connected to electrode terminals, wherein one or more electrically insulating magnetic gap layers are disposed over the whole surface of the stack, and an electrically insulating non-magnetic pattern corresponding to the conductor pattern shape is disposed close to the conductor patterns between the conductor patterns that overlap at intervals.

In the stacked inductor disclosed in International Publication No. WO 2008/007705, since an electric insulating non-magnetic pattern corresponding to the conductor pattern shape is disposed close to the conductor pattern between the conductor patterns that overlap at intervals, a minute magnetization loop is prevented from occurring in the periphery of the coil at low bias direct current (DC), therefore a rapid flow-in of a magnetic flux between the conductor patterns does not occur, a sharp change in the inductance is prevented, and it is expected to suppress the increase in AC resistance. That is, in International Publication No. WO 2008/007705, it is tried to suppress the increase in AC resistance by structural approach of the stacked inductor.

### SUMMARY OF THE INVENTION

In view of the above situation, the present invention provides an inductor with low ACR/L and high efficiency and also provides electronic and electric equipment mounted with the inductor.

In one aspect, the present invention provided for solving the above problems is an inductor including connecting terminals, a conductor that is electrically connected to the connecting terminals and can generate an induction field by electrification, and a core that embeds at least a part of the conductor and includes a metal powder, wherein when electrical characteristics obtained by application of AC to the inductor are fitted using the following equation (1) having two parameters, one of the two parameters, the parameter a, is 100 mΩμH⁻¹A^{-b} or less.

$$ACR / L = a \times I o {p}^{b} \qquad ( 1 )$$

Here, ACR is the AC resistance value (unit: mΩ) when AC of 1 MHz is applied, L is self-inductance (unit: μH), Iop is the ripple current amplitude (unit: A) of the applied AC, and b is the other of the two parameters (unit: dimensionless).

The inductor with a parameter a of 100 mΩμH⁻¹A^{-b} or less tends to have high efficiency (proportion of output power to input power, unit: %). In the above inductor, the parameter a may be 95 mΩμH⁻¹A^{-b} or less.

In the above inductor, the metal powder may have a composition including 30 mass % or more and 70 mass % or less of Ni, a balance of Fe, and impurities. In this case, the metal powder may include a first particle containing a crystalline phase. The first particle may have a median diameter D50-1 of 0.02 μm or more and 1.3 μm or less.

The metal powder may include a second particle containing an amorphous phase. The second particle may have a composition including P.

The second particle may have a composition including P: 5.0 to 13.0 atm %, C: 2.2 to 13.0 atm %, Ni: 0 to 10.0 atm %, B: 0 to 9.0 atm %, Si: 0 to 7.0 atm %, Cr: 0 to 6.0 atm %, and Sn: 0 to 3.0 atm %, a balance of Fe, and impurities. In the composition, Ni, B, Si, Cr, and Sn are optional additional elements. The second particle may have a median diameter D50-2 of 3.0 μm or more and 15.0 μm or less.

The metal powder may have a median diameter D50 of 6.0 μm or less. The parameter b may be 0.10 or more and 0.30 or less.

In another aspect, the present invention provides electronic and electric equipment mounted with the inductor according to one aspect of the present invention described above. In the electronic and electric equipment, the inductor is connected to a substrate via connecting terminals. The circuit in which the inductor of the electronic and electric equipment is built is not particularly limited, but when the inductor is used in a switching power supply circuit such as a DC-DC converter, it is easy to take advantage of the advantage of the inductor that the AC resistance value does not easily increase.

According to the present invention, an inductor with low ACR/L and high efficiency and electronic and electric equipment mounted with the inductor are provided.

### BRIEF DESCRIPTION OF THE DRAWINGS

FIG. 1 is a schematic view of an inductor according to one embodiment of the present invention;

FIG. 2 is a graph for explaining the equation (1), wherein the measurement results of electrical characteristics of the inductors of one of Invention Examples and one of Comparative Examples are plotted with ACR/L on the vertical axis and Iop on the horizontal axis;

FIG. 3 is a graph showing a relationship between the parameter a and the efficiency (%) in a plurality of inductors including inductors according to one embodiment of the present invention; and

FIG. 4 is a graph showing a relationship between the parameter a and the efficiency (%) in inductors according to Examples.

### DESCRIPTION OF THE PREFERRED EMBODIMENTS

Embodiments of the present invention will now be described in detail.

### 1. Inductor

In the present specification, the term “inductor” means a passive device including a core, such as a pressed powder core, and a conductor.

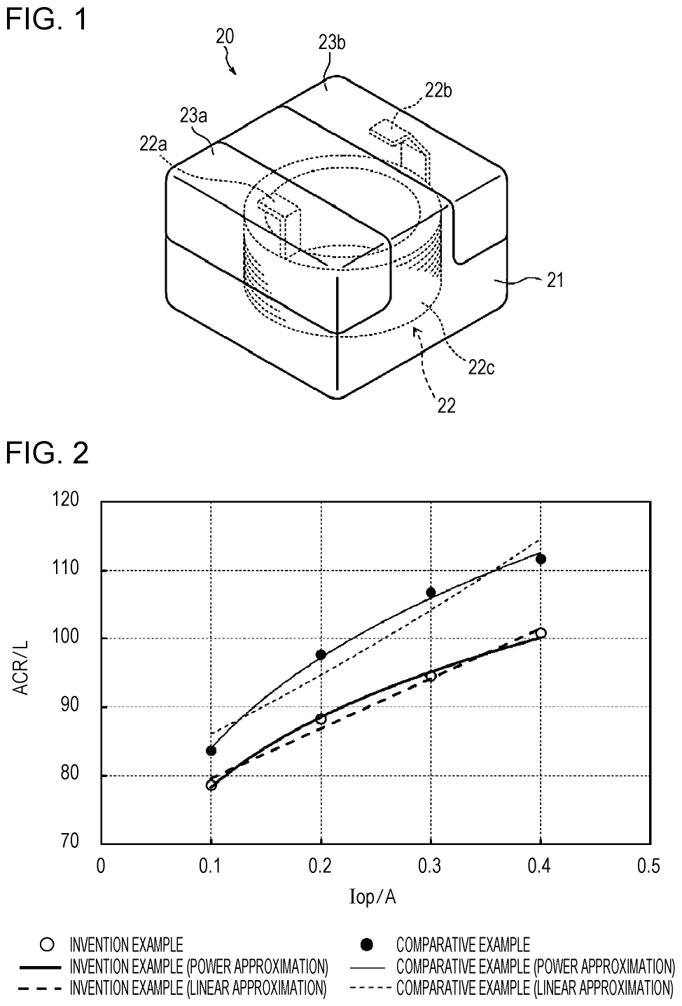

FIG. 1 is a view showing an example of the inductor according to one embodiment of the present invention. The inductor 20 includes connecting terminals 23a and 23b, a coated conductive wire 22 including a conductor, and a core (pressed powder core 21) including a metal powder. The inductor 20 can be formed into a small chip shape of several millimeters square, and a coil portion 22c consisting of the coated conductive wire 22 is embedded inside the pressed powder core 21 with a box shape. The conductor of the coil portion 22c generates an induction field during electrification, and the magnetic flux lines of this induction field pass through the pressed powder core 21. The ends 22a and 22b of the coated conductive wire 22 are exposed to the surface of the pressed powder core 21. A part of the surface of the pressed powder core 21 is coated with the connecting terminals 23a and 23b that are electrically independent from each other. The connecting terminal 23a is electrically connected to the end 22a of the coated conductive wire 22, and the connecting terminal 23b is electrically connected to the end 22b of the coated conductive wire 22. In the coil-embedded inductor 20 shown in FIG. 1, the end 22a of the coated conductive wire 22 is coated with the connecting terminal 23a, and the end 22b of the coated conductive wire 22 is coated with the connecting terminal 23b.

The method for embedding the coil portion 22c of the coated conductive wire 22 in the pressed powder core 21 is not limited. The member wound by the coated conductive wire 22 is disposed in a metal mold, a mixture (granulated powder) including a magnetic powder is further supplied in the metal mold, and pressure molding may be performed. Alternatively, multiple members pre-molded in advance from a mixture (granulated powder) including a magnetic powder are prepared, these members are assembled, and the coated conductive wire 22 is disposed in the gap formed at that time to obtain an assembly. This assembly may be pressure-molded. The details of the pressed powder core 21 will be described later.

The material of the coated conductive wire 22 including the coil portion 22c is not limited. Examples of the material include copper and a copper alloy. The coil portion 22c may be an edgewise coil. The conductor of the coil portion 22c may be formed by a plating process. In this case, the insulating material may be provided so as to coat the conductor formed by the plating process to constitute the coated conductive wire 22.

The materials and constitutions of the connecting terminals 23a and 23b are not limited as long as they have appropriate conductivity. A non-limiting example of the connecting terminals 23a and 23b is a layer having a structure of Cu plating/Ni plating/Sn plating from the side close to the surface of the pressed powder core 21. The connecting terminals 23a and 23b may be constituted of application-type electrodes based on conductive paste in which a conductive material such as silver is dispersed in a resin or the like. The connecting terminals 23a and 23b may each be a combination of plating containing copper, aluminum, zinc, nickel, iron, tin, or the like and an application-type electrode.

When electrical characteristics obtained by applying AC to the inductor 20 are fitted (power approximation) using the following equation (1) having two parameters, one of the two parameters, the parameter a, is 100 mΩμH⁻¹ A^{-b} or less. In the following explanation, the description of the unit of the parameter a may be omitted.

$$ACR / L = a \times I o {p}^{b} \qquad ( 1 )$$

Here, ACR is the AC resistance value (unit: mΩ) when AC of 1 MHz is applied, L is self-inductance (unit: μH), Iop is the ripple current amplitude (unit: A) of the applied AC, and b is the other of the two parameters (unit: dimensionless).

FIG. 2 is a graph for explaining the equation (1), wherein the measurement results of electrical characteristics of the inductors of one of Invention Examples and one of Comparative Examples described below are plotted with ACR/L on the vertical axis and Iop on the horizontal axis. Specifically, the measurement of the electrical characteristics was performed by applying 1 MHz AC having a prescribed ripple current amplitude Iop to the inductor 20 and measuring the AC resistance value ACR and the self-inductance L.

As obvious from FIG. 2, as a basic tendency, there is a positive correlation between the ripple current amplitude Iop and the ACR/L, and in the relationship between the Iop and the ACR/L, the fitting accuracy of power approximation is higher than that of linear approximation as described below.

In FIG. 2, the thick solid line indicates the results of power approximation for Invention Examples (white circles “∘” in FIG. 2), and the thick dashed line indicates the results of linear approximation for Invention Examples. The thin solid line indicates the results of power approximation for Comparative Examples (black circles “•” in FIG. 2), and the thin dashed line indicates the results of linear approximation for Comparative Examples. In order to verify the accuracy of these fitting, the results of determined respective coefficients of determination (R²) of approximate curves are shown in Table 1.

TABLE 1

| | | R² |
|---|---|---|
| Example | Power approximation | 0.9963 |
| | Linear approximation | 0.9874 |
| Comparative | Power approximation | 0.9959 |
| Example | Linear approximation | 0.9536 |

As shown in Table 1, in the power approximation, the coefficient of determination (R²) is 0.99 or more to indicate good approximation. In contrast, in the linear approximation, the coefficient of determination (R²) is less than 0.99 not to indicate good approximation by comparing with the power approximation. Accordingly, the relationship between the Iop and the ACR/L in the power approximation is appropriate than that in the linear approximation.

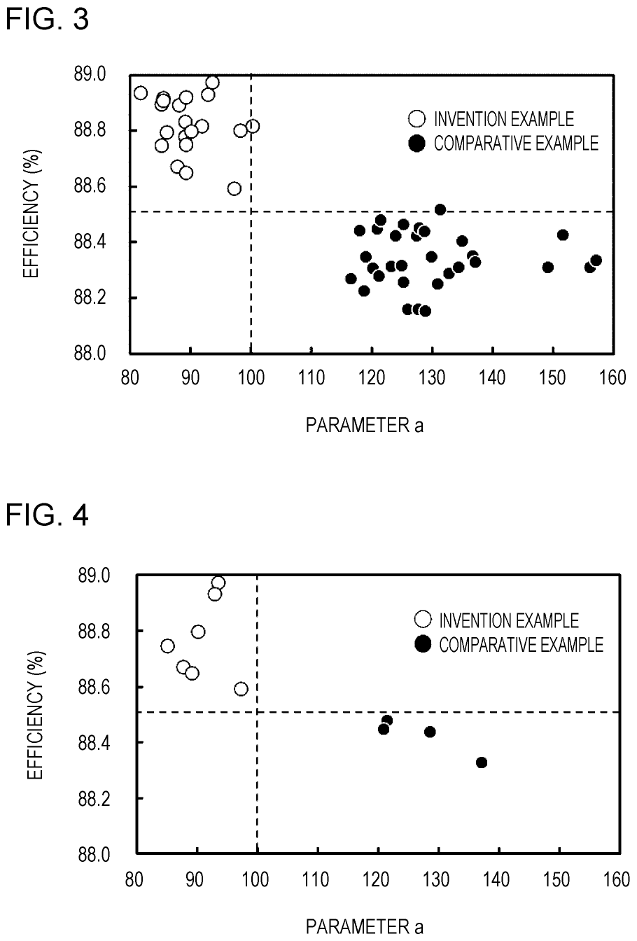

FIG. 3 is a graph showing a relationship between the parameter a and the efficiency (%) in a plurality of inductors including inductors according to one embodiment of the present invention (here, the efficiency is a value at a relatively low current load, I=1 A). When the measurement results of electrical characteristics of a plurality of inductors 20 including different types of the pressed powder cores 21 are fitted by the above equation (1), the inductor 20 of which the parameter a of the two parameters (parameter a and parameter b) of the equation (1) is low has a tendency of increasing the efficiency (proportion of output power to input power, unit: %). Specifically, in the results of FIG. 3, the inductor 20 having a parameter a of 100 or less can stably have an efficiency of greater than 88.5%. When the parameter a regarding the inductor 20 is 95 or less, the efficiency is more increased.

To explain this point from the viewpoint of evaluation method, AC of 1 MHz is applied to the inductor 20 while changing the prescribed ripple current amplitude Iop, and the AC resistance value ACR and the self-inductance L are measured. Whether an inductor 20 has high efficiency or not can be determined by fitting the obtained measurement results to the above equation (1) and evaluating whether the fitting parameter a is 100 or less or not.

The range of the parameter b when the electrical characteristics of the inductor 20 according to the present embodiment are fitted by the above equation (1) is not particularly limited. From the viewpoint of more stably increasing the efficiency of the inductor 20, the parameter b is preferably 0.10 or more and 0.30 or less and more preferably 0.13 or more and 0.26 or less.

### 2. Pressed Powder Core

As long as the inductor 20 according to one embodiment of the present invention has the above-mentioned characteristics, the structure and composition of the pressed powder core 21 in the inductor 20 are not limited. The inductor 20 having the above characteristics according to one embodiment of the present invention is easily obtained by using a pressed powder core 21 described below.

### (1) First Particle

The pressed powder core 21 may have a composition including 30 mass % or more and 70 mass % or less of Ni, a balance of Fe, and impurities and may include a first particle containing a crystalline phase. In the first particle containing a crystalline phase, a diffraction spectrum having a peak that is clear enough to identify the type of material of the crystalline phase is obtained by usual X-ray diffraction measurement.

The median diameter D50-1 (unit: μm), which is the particle size at which the cumulative particle size distribution from small particle size side is 50% in the volume-based particle size distribution, of the first particle measured by a laser diffraction/scattering method may be 0.02 μm or more and 1.3 μm or less. When the median diameter D50-1 is within this range, the iron loss Pcv of the pressed powder core 21 easily decreases. From the viewpoint of more decreasing the iron loss Pcv of the pressed powder core 21, the median diameter D50-1 is preferably 1.0 μm or less.

The particle size of the first particle can also be obtained by analyzing the image (secondary electron image) obtained by imaging a section of the pressed powder core 21 with a scanning electron microscope. In this case, the average equivalent circle diameter of a plurality of crystalline particles in the observation field of view is preferably 1.0 μm or less and more preferably 0.3 μm or more and 0.7 μm or less.

The composition of the first particle includes Fe and Ni and preferably consists of Fe and Ni. In the inductor 20 including the pressed powder core 21 having such a composition, the AC resistance value ACR tends to be low compared to the case where the composition of the first particle contains an element, such as Si or Cr, instead of Ni. From the viewpoint of enhancing the magnetic characteristics of the pressed powder core 21 including the first particle, the composition of a plurality of crystalline particles more preferably includes 10 mass % or more and 90 mass % or less of Ni and includes a balance of Fe and impurities and particularly preferably has a composition including 40 mass % or more and 60 mass % or less of Ni. The structure of the first particle may consist of a crystalline phase.

### (2) Second Article

The pressed powder core 21 according to the present embodiment may include a second particle containing an amorphous phase. Since the second particle contains an amorphous phase, (A) a diffraction spectrum obtained by a usual X-ray diffraction method has a broad peak and/or (B) a DSC curve obtained by differential thermal analysis includes a peak indicating crystallization, i.e., an exothermic peak associated with a phase change from an amorphous phase to a crystalline phase is satisfied. The metallic part of the second particle may be constituted of an amorphous phase only or may have an amorphous phase and a crystalline phase.

The second particle may have preferably a median diameter D50-2 of 3.0 μm or more and 15.0 μm or less and more preferably 3.0 μm or more and 12.0 μm or less. When the median diameter D50-2 is within this range, a reduction of the iron loss Pcv of the pressed powder core 21 is achieved. The median diameter D50-2 may be more preferably 5.0 μm or more and 9.0 μm or less and particularly preferably 5.5 μm or more and 7.5 μm or less from the viewpoint of an adequate handling property and availability of the second particle and improving the magnetic characteristics of the pressed powder core 21.

The particle size of the second particle can also be obtained by analyzing the image (secondary electron image) obtained by imaging a section of the pressed powder core 21 with a scanning electron microscope. In this case, the average equivalent circle diameter of the second particle in the observation field of view may be 1.0 μm or more and 8.0 μm or less and is preferably 2.0 μm or more and 6.0 μm or less.

In an example when the metallic part of the second particle is an amorphous particle consisting of substantially an amorphous phase, the metallic part of the second particle has a composition including B and P.

An example of the constituent material of the metallic part in this case is an Fe—P—C alloy. The composition of the Fe—P—C alloy may consist of 1.0 to 13.0 atm % of P, 1.0 to 13.0 atm % of C, Fe, and impurities. This Fe—P—C alloy may include one or more selected from the group consisting of Ni, Sn, Cr, B, and Si as optional elements. In this case, for example, the amount of Ni may be 0 to 10.0 atm %, the amount of Sn may be 0 to 3.0 atm %, the amount of Cr may be 0 to 6.0 atm %, the amount of B may be 0 to 9.0 atm %, and the amount of Si may be 0 to 7.0 atm %. The amount of Fe is preferably 65 atm % or more.

Examples of the Fe—P—C alloy include those having the following composition including:
P: 5.0 atm % or more and 13.0 atm % or less;
C: 2.2 atm % or more and 13.0 atm % or less;
Ni: 10.0 atm % or less;
B: 9.0 atm % or less;
Si: 10.0 atm % or less;
Cr: 6.0 atm % or less;
Sn: 3.0 atm % or less; and
a balance of Fe, and impurities.

In the above composition, Ni, B, Si, Cr, and Sn are optional elements. Accordingly, the lower limit of the amount of these optional elements is 0 atm %.

Another example of the constituent material of the metallic part is an Fe—B—C alloy. Examples of this Fe—B—C alloy include those having the following composition including:
B: 5.0 atm % or more and 16.0 atm % or less;
C: 2.0 atm % or more and 10.0 atm % or less;
Si: 12.0 atm % or less;
Ni: 10.0 atm % or less;
Cr: 6.0 atm % or less;
Sn: 3.0 atm % or less; and
a balance of Fe, and impurities.

In the above composition, Si, Ni, Cr, and Sn are optional elements. Accordingly, the lower limit of the amount of these optional elements is 0 atm %. In this case, the amount of C is preferably 5.0 atm % or more.

In an example when the second particle contains an amorphous phase and a crystalline phase, the second particle is a nanocrystal particle including a metallic part containing a crystalline phase having a Scherrer size of 50 nm or less. This metallic part may consist of a crystalline phase having a Scherrer size of 50 nm or less and an amorphous phase surrounding the crystalline phase.

As a non-limiting example, the nanocrystal particle may have a composition containing 5 atm % or more and 20 atm % or less of one or more elements X selected from the group consisting of C, B, P, and Si and 1 atm % or more and 10 atm % or less of one or more elements M selected from the group consisting of Mo, Nb, Cu, Zr, Al, and V and including a balance of Fe and impurities. In this case, the crystalline phase having a Scherrer size of 50 nm or less is easily generated.

In an example of the nanocrystal particle, the metallic part thereof is constituted of an Fe—Si—B—Nb—Cu alloy. The Fe—Si—B—Nb—Cu alloy may consist of 1.0 to 16.0 atm % of Si, 1.0 to 15.0 atm % of B, 0.50 to 8.0 atm % of Nb, and 0.50 to 5.0 atm % of Cu, a balance of Fe, and impurities. In this case, the amount of Fe is preferably 65 atm % or more.

In another example when the second particle contains an amorphous phase and a crystalline phase, the second particle is a particle mixture of an amorphous particle and a nanocrystal particle. In this case, the amorphous particle has a median diameter d2-1 of 3.5 μm or more and 9.0 μm or less and/or the nanocrystal particle has a median diameter d2-2 of 2.0 μm or more and 20 μm or less may be satisfied.

As described above, when the second particle includes an amorphous particle and a nanocrystal particle, the median diameter D50-2 of the second particle can be calculated as an approximate value from the median diameter d2-1 and the mixing proportion (mass ratio) of the amorphous particle and the median diameter d2-2 and the mixing proportion (mass ratio) of the nanocrystal particle. The median diameter D50-2 calculated as above may be 3.0 μm or more and 9.0 μm or less as mentioned above.

The metallic part of the amorphous particle may include a crystalline phase that inevitably occurs during the process.

### (3) Metal Powder

The metal powder in the pressed powder core 21 may be soft magnetic and preferably has a median diameter D50 of 8.0 μm or less. When the metal powder is a mixture of a plurality of types of particles (specifically, a mixture of the first particle and the second particle is exemplified), the median diameter D50 of the metal powder can be approximately calculated from the median diameters and the mixing proportions (mass ratios) of the various types of particles. When the pressed powder core 21 has a median diameter D50 within this range, the obtained inductor 20 can have high efficiency. From the viewpoint of more enhancing the efficiency of the inductor 20 while securing the adequate handling property of the metal powder when the pressed powder core 21 is manufactured, the median diameter D50 may be preferably 2.0 μm or more and 6.0 μm or less and more preferably 2.5 μm or more and 5.0 μm or less.

When the metal powder includes the first particle and the second particle, the mass ratio C1 of the first particle to the metal powder is preferably 10 mass % or more and 90 mass % or less and more preferably 10 mass % or more and less than 50 mass %. The first particle is softer than the second particle and can be deformed so as to fill between the individual second particles in the pressed powder core 21. Accordingly, when the mass ratio C1 of the first particle is less than 50 mass %, the AC resistance value ACR of the inductor 20 including the pressed powder core 21 easily decreases.

When the metal powder includes the first particle and the second particle, the mass ratio C2 of the second particle to the metal powder (the sum of the mass ratio C2-1 of the amorphous particle and the mass ratio C2-2 of the nanocrystal particle) is preferably 10 mass % or more and 90 mass % or less and more preferably 30 mass % or more and less than 80 mass % from the viewpoint of increasing the filling rate of the metal powder and enhancing the self-inductance L.

The shape of the metal powder is not limited. The metal powder may be spherical, elliptical, or scalelike or may have an indeterminate shape. The manufacturing methods for obtaining these shapes are also not limited.

The metal powder may be subjected to surface insulation treatment. When the metal powder is subjected to surface insulation treatment, the insulation resistance of the pressed powder core 21 is improved. The type of the surface insulation treatment for the metal powder is not limited, and examples thereof include phosphating, phosphatizing, and oxidation. The soft magnetic powder may have an insulating layer on the surface thereof. This insulating layer may include O (oxygen) and at least one selected from the group consisting of Si, P, and B.

### (4) Other Materials

The pressed powder core 21 may further include an optional auxiliary raw material in addition to the metal powder. The optional auxiliary raw material is, for example, a binding material and a modifier. The binding material binds individual particles, such as the metal powder, contained in the pressed powder core 21. This binding material is preferably an insulating material for imparting insulation resistance to the pressed powder core 21.

The binding material may be an organic material or an inorganic material. The organic material may be a resin material. Examples of the resin material include an acrylic resin, a silicone resin, an epoxy resin, a phenolic resin, a urea resin, a melamine resin, and a polyester resin. The inorganic material may be a glass material such as water glass. The binding material may be a product of a reaction such as thermal decomposition or a mixture of a plurality of materials. The modifier, for example, improves the fluidity of a metal powder or adjusts the curing rate of the binding material. The modifier may be a glass material.

### (5) Manufacturing Method

The method for manufacturing the pressed powder core 21 is not particularly limited. As an example, the method for manufacturing the pressed powder core 21 includes a molding step described below and may further include a heat treatment step.

### (5-1) Molding Step

First, a mixture including a metal powder and a component that gives a binding component in the pressed powder core 21 is provided. The component (in the present specification, also referred to as “binder component”) that gives a binding component may be the binding component itself or may be a material different from the binding component. As the latter, specifically, for example, the binder component is a resin material, and the binding component is the pyrolysis residue of the resin material. Such a pyrolysis residue can be formed by a heat treatment step that follows the molding step as described below.

A molded product can be obtained by molding treatment including pressure molding of this mixture. The pressure conditions are not limited and may be appropriately set based on the composition of the binder component and so on. For example, when the binder component consists of a thermosetting resin, it is preferable to allow the curing reaction of the resin to proceed in a metal mold by heating with pressure. In contrast, in compression molding with high pressure, heating is not required, and pressure is applied for a short time. The pressurizing force in compression molding is appropriately set. Non-limiting examples are 0.5 GPa or more and 2 GPa or less and may be preferably 1 GPa or more and 2 GPa or less. In compression molding, pressure may be applied while heating or at ordinary temperature.

The mixture may be a granulated powder containing a metal powder and a binder component. The granulated powder may contain a material other than the metal powder and the binder component. Examples of the material include a lubricant, a silane coupling agent, and an insulating filler. The method for manufacturing the granulated powder is not particularly limited. The granulated powder may be obtained by directly kneading components that give the granulated powder and pulverizing the obtained kneaded matter by a known method, or the granulated powder may be obtained by preparing a slurry obtained through addition of a dispersion medium (of which one example is water) to the above components, drying the slurry, and pulverizing it. The particle size distribution of the granulated powder may be controlled after the pulverization by performing sieving or classification.

### (5-2) Heat Treatment Step

The pressed powder core 21 may be the molded product obtained by the molding step or may be obtained by subjecting the molded product to a heat treatment step as described below.

In the heat treatment step, the molded product obtained by the above molding step is heated to adjust the magnetic characteristics through amendment of the distance between metal powder particles and to adjust the magnetic characteristics through mitigation of the distortion imparted to the metal powder in the molding step.

The purpose of the heat treatment step is to adjust the magnetic characteristics of the pressed powder core 21 as described above, and the heat treatment conditions such as heat treatment temperature are set such that the magnetic characteristics of the pressed powder core 21 are optimized. In an example of the method for setting the heat treatment conditions, the highest heating temperature (annealing temperature) of the molded product is changed, and other conditions such as the temperature-rising rate and the holding time at heating temperature are constant.

### 3. Inductor, and Electronic and Electric Equipment

The electronic and electric equipment according to one embodiment of the present invention is electronic and electric equipment mounted with the above-described inductor 20 according to one embodiment of the present invention, wherein the inductor 20 is connected to a substrate via the connecting terminals thereof. An example of a circuit including the inductor 20 is a switching power supply circuit such as a DC-DC converter. In the switching power supply circuit, in order to respond to various demands such as size reduction, weight reduction, and high functionality of the electronic and electric equipment, the switching frequency tends to increase, and the amperage flowing in the circuit tends to increase. Accordingly, the current flowing in the inductor 20, which is a component of the circuit, also tends to have a higher variable frequency and an increased average amperage.

Regarding this point, as described above, the inductor 20 according to one embodiment of the present invention has low ACR/L and high efficiency. Accordingly, the problem of heat generation is less likely to be caused in the inductor 20. Therefore, the electronic and electric equipment mounted with the inductor 20 according to one embodiment of the present invention can be provided with high functionality while corresponding to size reduction and weight reduction.

The embodiments described above have been described to facilitate understanding of the present invention, and are not described to limit the present invention. Accordingly, each element disclosed in the above embodiments is intended to include all design changes and equivalents that fall within the technical scope of the present invention.

### EXAMPLES

The present invention will now be more specifically described by Examples and so on, but the scope of the present invention is not limited to these Examples and so on.

### Example 1

### (1) Preparation of Metal Powder

First particles having median diameters D50-1 and compositions shown in Table 2 were provided. In Table 2, “FeSiCr” means an Fe—Si—Cr alloy having a Si content of 3.5 mass % and a Cr content of 4.5 mass % and including a balance of Fe and impurities, and “FeNi” means an Fe—Ni alloy having a Ni content of 50 mass % and including a balance of Fe and impurities.

As one type of the second particle, an amorphous particle consisting of an Fe—P—C alloy and having a median diameter d2-1 shown in Table 2 was prepared by weighing raw materials so as to include Fe, Ni, Cr, P, C, and B as elements and to give a predetermined composition and melting them into the above-described Fe—P—C alloy. The chemical composition of the obtained amorphous particle consisted of 6 atm % of Ni, 2 atm % of Cr, 11 atm % of P, 8 atm % of C, 2 atm % of B, a balance of Fe, and impurities.

As another type of the second particle, a nanocrystal particle including Fe, Si, B, Nb, and Cu as elements, including a metallic part composed of a crystalline phase having a Scherrer size of 50 nm or less and an amorphous phase, and having a median diameter d2-2 shown in Table 2 was prepared. The chemical composition of the obtained amorphous particle consisted of 6 atm % of Ni, 2 atm % of Cr, 11 atm % of P, 8 atm % of C, 2 atm % of B, a balance of Fe, and impurities.

TABLE 2

| | | | | Second particle | | | | | | | Pressed powder core | | |
|---|---|---|---|---|---|---|---|---|---|---|---|---|---|
| | First particle | | | Amorphous | | Nanocrystal | | | | Metal | Resin | | |
| | | C1 | | | C2-1 | | C2-2 | | C2 | powder | amount | Annealing | |
| Example | D50-1 | mass | Compo- | d2-1 | mass | d2-2 | mass | D50-2 | mass | D50 | part by | temperature | |
| No. | μm | % | sition | μm | % | μm | % | μm | % | μm | mass | ° C. | Remarks |
| 1 | 2.0 | 20 | FeSiCr | 5.5 | 56 | 27 | 24 | 12 | 80 | 10.0 | 2.0 | 325 | Comparative |
| | | | | | | | | | | | | | Example |
| 2 | 2.0 | 40 | FeSiCr | 5.5 | 42 | 27 | 18 | 12 | 60 | 8.0 | 2.0 | 325 | Comparative |
| | | | | | | | | | | | | | Example |
| 3 | 2.0 | 40 | FeSiCr | 6.5 | 60 | 0 | 0 | 6.5 | 60 | 4.7 | 1.5 | 375 | Comparative |
| | | | | | | | | | | | | | Example |
| 4 | 2.0 | 40 | FeSiCr | 8.0 | 42 | 4.0 | 18 | 6.8 | 60 | 4.9 | 1.5 | 375 | Comparative |
| | | | | | | | | | | | | | Example |
| 5 | 0.9 | 40 | FeNi | 5.5 | 60 | 0 | 0 | 5.5 | 60 | 3.7 | 2.0 | 350 | Invention |
| | | | | | | | | | | | | | Example |
| 6 | 0.9 | 40 | FeNi | 5.5 | 60 | 0 | 0 | 5.5 | 60 | 3.7 | 1.5 | 375 | Invention |
| | | | | | | | | | | | | | Example |
| 7 | 0.6 | 40 | FeNi | 5.5 | 30 | 4.0 | 30 | 4.8 | 60 | 3.1 | 1.5 | 400 | Invention |
| | | | | | | | | | | | | | Example |
| 8 | 0.6 | 40 | FeNi | 0.0 | 0 | 7.5 | 60 | 7.5 | 60 | 4.7 | 1.5 | 350 | Invention |
| | | | | | | | | | | | | | Example |
| 9 | 0.6 | 40 | FeNi | 5.5 | 60 | 0 | 0 | 5.5 | 60 | 3.5 | 2.0 | 375 | Invention |
| | | | | | | | | | | | | | Example |
| 10 | 0.6 | 40 | FeNi | 5.5 | 60 | 0 | 0 | 5.5 | 60 | 3.5 | 2.3 | 375 | Invention |
| | | | | | | | | | | | | | Example |
| 11 | 0.9 | 10 | FeNi | 5.5 | 60 | 11 | 30 | 5.5 | 60 | 6.9 | 2.5 | 375 | Invention |
| | | | | | | | | | | | | | Example |

The particle size distributions of the prepared first particle and second particle were each determined by measuring the volume distribution using a particle size analyzer (manufactured by Nikkiso Co., Ltd., “Microtrac particle size distribution-measuring apparatus MT3300EX”) by a laser diffraction/scattering method. The median diameter is, as described above, the particle size (unit: μm) at which the cumulative particle size distribution from small particle size side is 50% in the volume-based particle size distribution determined as above.

### (2) Preparation of Metal Powder

A metal powder was obtained by mixing two or three selected from the first particles and the second particles at a prescribed proportion shown in Table 2 (C1: mixing proportion of a first particle in a metal powder, C2: mixing proportion of a second particle in metal powder, C2-1: mixing proportion of an amorphous particle in a metal powder, C2-2: mixing proportion of a nanocrystal particle in a metal powder, all units are mass %). The calculation results of the median diameter D50 (unit: μm) of the metal powders are shown in Table 2.

### (3) Manufacturing of Pressed Powder Core

A slurry was obtained by mixing an insulating binding material consisting of an acrylic resin and a phenolic resin in an amount (parts by mass) shown in the “Resin amount” column in Table 2 and 0 to 0.5 parts by mass of a lubricant consisting of zinc stearate with 100 parts by mass of the obtained metal powder and further using water as a solvent. A granulated powder was obtained from the obtained slurry using a spray drying apparatus. The obtained granulated powder was packed in a metal mold in which a coated conductive wire 22 was disposed and was pressure molded at a surface pressure of 980 MPa to obtain a coil-embedded molded product with 3.0 mm length, 3.25 mm width, and 1.1 to 1.2 mm thickness. The obtained coil-embedded molded product was placed in a furnace in a nitrogen flow atmosphere and was subjected to heat treatment by increasing the furnace temperature from room temperature (23° C.) to the annealing temperature shown in Table 2 at a temperature-rising rate of 10° C./min, maintaining this temperature for 1 hour, and then decreasing the temperature in the furnace to room temperature to obtain a pressed powder core 21 with an embedded coil portion 22c. The pressed powder core 21 was provided with connecting terminals 23a and 23b consisting of application-type electrodes, and the connecting terminals 23a and 23b and the conductor of the coated conductive wire 22 were electrically connected to obtain an inductor 20.

### Test Example 1: Measurement of Electrical Characteristics

The self-inductance L (unit: μH), AC resistance value ACR (unit: mΩ), and efficiency (unit: %) of each of the inductors produced in Examples were measured. Here, the efficiency was a value when a relatively low current, I=1 A, flowed. The AC resistance value ACR was measured while changing the ripple current amplitude Iop (unit: A) of applied AC from 0.1 A to 0.4 A. The measurement results are shown in Table 3.

### Evaluation Example 1: Power Approximation

The ACR/L calculated from the self-inductance L and AC resistance value ACR measured in Test Example 1 was plotted with respect to the ripple current amplitude Iop. The power approximation shown in the above equation (1) was performed on the plotted results to determine two parameters (parameter a and parameter b). The results are shown in Table 3. FIG. 4 is a graph showing a relationship between the parameter a and the efficiency (%) in the inductors according to Examples.

TABLE 3

| Example | L | ACR (mΩ) | | | | ACR/L (mΩ · μH⁻¹) | | | | | | Efficiency | |
|---|---|---|---|---|---|---|---|---|---|---|---|---|---|
| No. | μH | 0.1 A | 0.2 A | 0.3 A | 0.4 A | 0.1 A | 0.2 A | 0.3 A | 0.4 A | a | b | % | Remarks |
| 1 | 0.726 | 58.6 | 66.4 | 70.5 | 75.4 | 80.7 | 91.4 | 97.1 | 103.9 | 121.4 | 0.18 | 88.5 | Comparative |
| | | | | | | | | | | | | | Example |
| 2 | 0.738 | 62.2 | 71.5 | 77.7 | 83.9 | 84.2 | 96.9 | 105.3 | 113.9 | 137.0 | 0.21 | 88.3 | Comparative |
| | | | | | | | | | | | | | Example |
| 3 | 0.675 | 46.1 | 57.9 | 65.1 | 65.4 | 68.2 | 85.7 | 96.5 | 96.8 | 128.6 | 0.27 | 88.4 | Comparative |
| | | | | | | | | | | | | | Example |
| 4 | 0.646 | 40.4 | 50.8 | 57.0 | 58.8 | 62.6 | 78.6 | 88.3 | 91.0 | 120.8 | 0.28 | 88.5 | Comparative |
| | | | | | | | | | | | | | Example |
| 5 | 0.678 | 36.0 | 42.4 | 46.4 | 46.8 | 53.0 | 62.5 | 68.4 | 69.0 | 85.1 | 0.20 | 88.7 | Invention |
| | | | | | | | | | | | | | Example |
| 6 | 0.718 | 37.4 | 44.2 | 48.7 | 53.7 | 52.1 | 61.6 | 67.8 | 74.9 | 93.5 | 0.26 | 89.0 | Invention |
| | | | | | | | | | | | | | Example |
| 7 | 0.601 | 37.3 | 43.1 | 46.8 | 48.4 | 62.1 | 71.8 | 77.9 | 80.6 | 97.2 | 0.19 | 88.6 | Invention |
| | | | | | | | | | | | | | Example |
| 8 | 0.641 | 42.3 | 46.7 | 49.6 | 50.6 | 66.0 | 72.8 | 77.3 | 79.0 | 90.1 | 0.13 | 88.8 | Invention |
| | | | | | | | | | | | | | Example |
| 9 | 0.676 | 37.6 | 43.6 | 47.6 | 48.8 | 55.6 | 64.5 | 70.5 | 72.2 | 87.7 | 0.19 | 88.7 | Invention |
| | | | | | | | | | | | | | Example |
| 10 | 0.675 | 39.9 | 45.3 | 49.5 | 50.4 | 59.1 | 67.2 | 73.4 | 74.7 | 89.1 | 0.18 | 88.7 | Invention |
| | | | | | | | | | | | | | Example |
| 11 | 0.761 | 47.5 | 53.2 | 56.6 | 60.9 | 62.4 | 69.9 | 74.3 | 80.0 | 92.8 | 0.17 | 88.9 | Invention |
| | | | | | | | | | | | | | Example |

As shown in Table 3 and FIG. 4, it was observed that when the parameter a was 100 or less, the efficiency of the inductor exceeded 88.5%. In contrast, when the parameter a was greater than 100, the efficiency did not exceed 88.5%.

The inductor of the present invention can be suitably used as an inductor that is a component of a switching power supply circuit such as a DC-DC converter.

1. An inductor comprising:
connecting terminals;
a conductor electrically connected to the connecting terminals, the conductor being configured to generate an inductive magnetic field by energization; and
a core including a metal powder, in which the conductor is at least partially embedded,
wherein the inductor has electrical characteristics with respect to an alternating current applied thereto, the electrical characteristics being fitted using a following equation having two parameters a and b:
ACR/L=a×Iop^{b},
where ACR is an alternating-current resistance value (unit: mΩ) with respect to the alternating current of 1 MHz, L is self-inductance (unit: μH), lop is a ripple current amplitude (unit: A) of the alternating current applied, and the parameter b is dimensionless,
and wherein the inductor has such electrical characteristics that the parameter a in units of mΩμH⁻¹A^{-b} is equal to or smaller than 100.

2. The inductor according to claim 1, wherein the parameter a in units of mΩμH⁻¹ A^{-b} is equal to or smaller than 95.

3. The inductor according to claim 1,
wherein the metal powder has a composition containing:
equal to or greater than 30 mass % and equal to or smaller than 70 mass % of Ni; and
a balance of Fe and impurities,
and wherein the metal powder includes first particles containing a crystalline phase material.

4. The inductor according to claim 3, wherein the first particles have a median diameter D50-1 of 0.02 μm or more and 1.3 μm or less.

5. The inductor according to claim 1, wherein the metal powder includes second particles containing an amorphous phase material.

6. The inductor according to claim 5, wherein the second particles have a composition containing P.

7. The inductor according to claim 6, wherein the second particles have the composition containing:
P: 5.0 atm %≤x≤13.0 atm %;
C: 2.2 atm %≤y≤13.0 atm %;
Ni: 0 to 10.0 atm %;
B: 0 to 9.0 atm %;
Si: 0 to 7.0 atm %;
Cr: 0 to 6.0 atm %;
Sn: 0 to 3.0 atm %; and
a balance of Fe and impurities.

8. The inductor according to claim 5, wherein the second particles have a median diameter D50-2 equal to or greater than 3.0 μm and equal to or smaller than 15.0 μm.

9. The inductor according to claim 1, wherein the metal powder has a median diameter D50 equal to or smaller than 6.0 μm.

10. The inductor according to claim 1, wherein the parameter b is equal to or greater than 0.10 and equal to or smaller than 0.30.

11. An electronic/electric device comprising:
a substrate; and
the inductor according to claim 1,
wherein the inductor is connected to the substrate via the connecting terminals thereof.
